(19) United States
(12) Patent Application Publication
(10) Pub. No.: US 2002/0198735 A1
(43) Pub. Date: Dec. 26, 2002

(54) Marketing device and method of use for waiving time limitations on contracts

(76) Inventor: Ivan K. Tolbert, Richmond, VA (US)

Correspondence Address: Ivan K. Tolbert, P.O. Box 3905, Richmond, VA, 23235, US

(21) Appl. No.: 10/120,290

(22) Filed: Apr. 11, 2002

Related U.S. Application Data
(60) Provisional application No. 60/284,926, filed on Apr. 20, 2001.

(51) Int. Cl. G06F 17/60

(52) U.S. Cl. 705/1

(57) ABSTRACT

A device, method of use and process steps comprising a written waiver agreement that nullifies statutes of limitations laws or other time-delimiters used to block a contract partner's judicial remedy for future contract disputes that occur before expiration of the promised performance period. The serialized (10) device includes customizable data fields (12), signature fields for the contract parties (32), a contract beneficiary signature field (16) and a plurality of detachable restatement affidavits pledging (48) continuance of the invented device's provisions for a defined future period (38) (40) consistent with laws in a plurality of jurisdictions (28), to preserve original contract terms. Based on a voluntary decision, a contract partner will: 1) forego the device, 2) keep an existing contract with use of the device, 3) seek another contract partner who accepts provisions of the device (66), and/or 4) cancel the existing contract (70).

### CROSS-REFERENCE TO RELATED APPLICATIONS

This application claims the benefit of Provisional Patent Application Ser. No. 60/284,926 filed Apr. 20, 2000.

### BACKGROUND

1. Field of the Invention

This invention is a marketing device that relates to contracts, specifically to the negation of long-term contractual obligations by the imposition of statutes of limitations and other time restrictions on the right to a legal remedy for contract breach.

2. The Prior Art

The inventor encountered a significant dearth of relevant prior art concerning inventions within the scope of the relationship between statute of limitations laws, and other time bars, and their impact on long-term contract obligations. There are, however, several prior art instances of inventions with features that bear to some degree on certain physical and methodological aspects of this invented device, although none of these approach a functional equivalent. For example, in U.S. Pat. No. 1,634,240, Wilford includes detachable sections. Yet, these detachments do not provide the unique and novel advantages of the detachments of the present invention. Specifically, they are physical examination verification coupons for continued insurance coverage that do not trigger any new action in the operation of the device itself or alter the business relationship between contract parties, as does the detachable portions of the present invented device. In a similar fashion with regard to the present invention's business methods and process steps, Gamble, et al., in U.S. Pat. No. 6,163,770, present both the use of two distinct contract documents for insurance coverage on the same individual and the use of a digital electrical computer apparatus to generate printed documents, both features also incorporated within the operation of the present invention, Gamble's different purpose and outcome is to reduce the premium costs and the claims cost of long-term care insurance policies, using computer apparatus to perform financial calculations. Again, this does not alter the business relationship of the contract parties, nor accomplish the unique and novel purpose and outcome of the present invention.

Although statutory time restrictions on the legal right to a remedy for disputes on contracts are longstanding, and despite the fact that many thousands of people have been injured when their contract claims were not allowed because of these restrictions, it is likely that those having ordinary skill in the art, such as contract professionals, lawyers, judges, court administrators, contract breach plaintiffs and contract breach defendants, have thus far failed to solve this problem because of the following reasons: 1.) Claimant victims (contract breach plaintiffs) of the practice who have suffered significant financial losses and who have been denied the right to a legal remedy have a palpable sense of helplessness and powerlessness in the face of the powerful institutions of the law, and 2.) the reality of the significant economic benefits derived from the use of this practice by the named others with ordinary skill in the art—lawyers, judges, court administrators and contract breach defendants—have no incentive or inclination to alter a practice from which they substantially and directly benefit. Therefore, this invention and solution to this problem is needed to stem the increasing incidence of contract duty abrogation for contract breaches which escape scrutiny and find safe legal harbor in these laws, and to restore to consumers of contracts an expected and heightened degree of certainty in their ability to rely on the expressed terms and provisions of the contracts they sign.

Contracts in Society

The necessary and fundamental basis of a civil and humane society is the ability of one member of such society to rely, with a reasonably high degree of confidence and assurance, upon the integrity of the utterances, actions and expressions of another member of that same society in the conduct of ordinary societal affairs. This necessarily high degree of reliance permeates all manner of human interaction and enterprise, as between individuals, businesses, religions and governments and their individual or collective relationships one to another. For the common good of civil society as a whole, and to underscore the importance and protect the integrity of such interactions, all members of civil societies develop, promulgate and adhere to rules, regulations, laws, codes of conduct and expectation and, most of all, they enter into contracts.

The quintessential role of contracts in the maintenance and sustenance of civil behavior and human governance is as ancient as society itself. Contract law is well evolved within Western civilization and has been lionized in the legal canons of all great societies during several millennia. So essential and highly regarded has been the primacy of contracts to the basic underpinnings of civilization that America's founders shielded the inviolability of contracts behind what they believed would be an impenetrable wall in the United States Constitution: Article II, Section 10, wherein even its own states and territories were forbidden to pass any law “impairing the obligation of a contract.” When considering that very few powers were reserved from the states, exempting—along with impairment of contracts—such powerful authorities as those to coin money or to declare war, it is evident that the unfettered ability to create, enter into, maintain and enforce the integrity and the obligation of a contract was understood to be so primary to the maintenance and conduct of a free society that America's founders sought to protect this right as a constitutionally guaranteed liberty.

State Laws Impair Contracts

The history notwithstanding, it is clear today that even in America, and in many other advanced societies throughout the world, this fundamental freedom to contract without interference has been significantly impaired by laws of the states. Every state has adopted laws that impair the obligations of contracts. Indeed, these laws—called statutes of limitations, statutes of repose and time bars—do worse than impair contract obligations, they obliterate them. Further complicating the ability to create valid and true contracts even more is the fact that the states are inconsistent with regard to the arbitrary time periods specified within their statute of limitations laws as they apply to the rights of individuals to gain a remedy in court based upon a contract dispute. While some states allow as many as 15 years to lapse from the date the contract was created before a claim must be brought under it, some states offer as few as three years from the date of creation to do so. Moreover, states permit contract parties to impose even more restrictive limits than those limits specified in their contract law, and these shorter limits routinely are enforced by state courts. State imposed statute of limitations laws, without distinction or discrimination, are universally applied to all agreements characterized by law as contracts. No legal exception is made for longer-term contracts that promise performance that extends beyond the arbitrarily established legal time periods for bringing a legal claim on the basis of the contractually promised performance. Thus, any flawed contract or one with a breach embedded in a term clause at the time it is created can only be disputed within this arbitrary but legal time limit, even if the duty-to-perform under the contract is promised to occur only after the legal limitations time will have expired. Further, at least one state already has ruled that it is not necessary for any contract defendant to ever produce evidence of a claimed contract flaw that provides the basis for the breach of contract lawsuit; all that was required was an unsubstantiated and unproven supposition that an unseen flaw might have existed in order for the court to agree with the supposition, override the evidentiary contract language and rule against the plaintiff party to the contract. Under these conditions, ordinary consumers are further hampered in their ability to understand conditions and terms of the contracts they sign because a state's statute of limitations law, while never disclosed within the contract itself, is a de facto invisible clause in all contracts created in that state.

This invisible clause is legally enforced by state courts as if it were a fully disclosed and incorporated term in the contract instrument itself. By this means, the very basis for establishing breach or non-breach of a contract, therefore, need never be disclosed in order for the defendant contractual party to escape contract liability in state court. Among the many long-term contracts affected by this undisclosed condition are such ubiquitous consumer contracts as insurance policies of all kinds, mortgages, wills and final testaments, real estate title policies, building inspections, viatical agreements, sperm bank contracts, biomedical engineering and reproductive contracts, athlete contracts, historical preservation contracts, estate plans, employment agreements and many others; virtually all long-term contracts. At the time of this filing, the disclosed duration of contract promises are of no legal effect because the undisclosed state law limitations on every contract—which effectively impairs, obliterates or negates any and all long-term contract promises, with or without any legal evidence to support and verify them—is the norm in state courts. The purveyors of long-term contracts containing undisclosed statutory legal advantages derive undue benefits from the hidden (to their contractual partner) effects of state statute of limitations laws, since such laws undermine and limit the actual duration of, and legal liabilities associated with, performance duties written into their contracts. Courts have consistently held that the expiration time period under these laws does not begin to expire upon the discovery of a contract breach or injury caused by the contract, but rather the time period begins to expire immediately upon creation of the contract—irrespective of whether a breach has, or ever will, occur and equally irrespective of any longer-than-the-expiration-period performance duty promised within the contract itself. Because many contract breach lawsuits are allowed to proceed in the courts even though—knowingly by the courts and defendants—such state laws exist to deny the right to recovery in such time-barred cases, there are unnecessary deleterious effects upon taxpayers as well as contract claimants who bring such lawsuits. Claimants who typically already have suffered significant economic losses because of the contract breach itself are subjected by the courts to additional significant economic losses for legal expenses associated with bringing to court what the state law automatically renders a futile lawsuit and moot claim with no legal right to recovery. Taxpayers, who bear the burden of expense for court operations, also suffer tremendous economic loss through the prolific waste of public funds expended for the conduct of what are known to be futile trials. Because so many claimants already have lost their entire estates, or their health care, because of the breached contract, taxpayers must shoulder the additional expense of lifelong care for formerly self-sufficient taxpaying citizens who become permanent wards of the state's public welfare system. States do not automatically impose statute of limitations restrictions on all litigated contract disputes. Rather, legal defendants in contract disputes must affirmatively claim the protection of such laws as an active defense in order for time bars to apply in any litigated dispute. Consequently, the decision by a contract party defendant to shield itself from liability by the use of these laws is entirely a voluntary action. The invention influences this decision and this action by encouraging party defendants to prospectively volunteer, instead, not to invoke such laws in any future legal disputes pertaining to long-term contracts. By operation of this invented device, the advance voluntary decision to forego the statute of limitations litigation defense on the underlying contract itself becomes a disclosed term incorporated into the contract document.

No Understanding. No Negotiation

An important background consideration for analyzing the object and value for this invention is the very nature of how modern contracts are created in today's highly automated and highly complex societies. Gone are the days of a handshake and a solid reputation as the necessary elements to close a deal. Vanishing, too, is the critical element of negotiation in the establishment of a contract. Long ago, and in contract theory, negotiation between the parties to ensure that all sides clearly understood and agreed to the considerations and the obligations involved in a contract was required before any contract would be considered valid by the courts, or by anyone else. There was a clear and plain language disclosure standard for all terms in a contract (although statute of limitations effects always were exempt from this disclosure standard). This no longer is true. For instance, most software consumers who, within this context, might be considered ordinary practitioners skilled in the art of buying such contracts (having purchased so many of them) almost never read the contract, e.g., the software license agreement, before electronically signing the document and creating a contract obligation. Similarly, most insurance consumers never read the fine print of their policies before signing them, also creating a contract (a futile exercise in any event since applicable state law does not require that the “invisible clause” of an active time bar, which effectively overrides all other visible contract language, must ever actually be disclosed in any way). In many instances, the legal fine print is never given to the third-party beneficiary (contract party) of a large group policy; only a policy “certificate” paraphrasing terms and conditions typically is provided. The reason most policyholders do not bother to ask for or read the available fine print is because they realize there is no real opportunity to negotiate the terms of the contract. More than ever before, consumers are being forced down a one-way street and into a one-sided, take-it-or-leave-it contract proposition, without so much as a verbal recitation or explanation of the express or implied contract terms for the benefit of those who may be illiterate, visually impaired or simply disinclined or unable to understand the fine print and complicated legal jargon that nonetheless will obligate them. They agree to enter into contracts almost exclusively on representations about the performance duties made outside the written contract instrument itself. Their understanding of what they agree to can have little or no relation to the actual terms of the document they unwittingly sign. Insurance contracts and software agreements are but two areas where most consumers generally do not know what it is that they are purchasing, but they understandably surmise it doesn't matter that they don't know because there is no opportunity to negotiate terms of the contract, in any event. Their choice is simply to accept whatever condition or term that might exist—whether disclosed or undisclosed—or to do without. Yet, many of these purchases, especially for insurance, are required by state law, so even the option to do without is not an option at all; there is a coercive legal impetus requiring that the contract be established and maintained.

### SUMMARY OF THE INVENTION

The inventor has discovered an important, longstanding and severe problem in the conflict that inherently exists between the generally undisclosed operation of state imposed limitations laws on contracts, and the routine creation and sale of long-term contract obligations that extend beyond these state law limitation periods, a problem for which no practical solution now exists. It is the unique and novel purpose of the invention to solve this problem by preserving contract party rights to a legal remedy throughout the life of long-term contracts, to foster widespread public awareness about the effects of statute of limitations laws on the legally enforceable duration of contractual agreements, and to engender marketplace changes in the construction, marketing and enforcement (or lack thereof) of contract agreements.

To this end, the invention provides a means for permitting consumers of contracts to gain a concession from existing or future contract parties to the effect that such contract parties will voluntarily, but contractually, agree to forego the use of legal time restrictions as a litigation defense to escape responsibilities and liabilities associated with mutually understood performance duties that are expressed as written terms and conditions of their contract agreements, thereby preserving the contract's promised duration, legal validity and legal remedies otherwise normally available to contract parties in the absence of statute of limitations law, or similar pre-existing contract provisions or time bars, in the event that disputes arising from or pertaining to those contracts ever rise to the level of court adjudication. An additional purpose is to encourage full, universal and conspicuous disclosure of all existing legal or extralegal, exparte or interstitial, conditions which potentially may affect the parties' mutual understanding of represented terms embodied in contract agreements as they were formally expressed, in writing and/or speaking, at the time of their creation. The present invention is a computer-based system and process for generating a separate, but related, legal contract agreement that prohibits the use of statute of limitations on underlying contract agreements between contractual partners. Without the availability of the present invented device, the only currently available means for a contract party to guarantee existence of a legal remedy for a possible future contract breach that occurs after the statutory limitations period has expired is to attempt to reestablish the contract prior to each date of expiration. This action, however, is neither feasible nor practical because the actual legal effect of this constitutes a cessation of the existing contract and the establishment of an entirely new, and legally unrelated contract in its place, opening the new contract to new negotiations over terms and conditions, for example, insurance premium increases associated with the increased morbidity that comes with age, and other effects that diminish the value of the contract for one of the parties as compared to the prior existing contract agreement. The present invented device solves this problem by the use of detachable affidavits that are signed at the time the invented device is first activated that apply prospectively to each statutory limitations interval prescribed by state law, thereby freezing and preserving the original terms, conditions and intent of the contract throughout the duration of the forthcoming limitations intervals.

Because—based upon extensive research and empirical evidence from practitioners with ordinary skill in the art—there now exists no contractual language or insurance policy clause that addresses the deleterious effect of statutes of limitations on the very long-term contracts they sell and the very laws they comfortably use to escape contract obligations, the invented device is not obvious. They perceive no problem. From their perspective none exists. Within this context, were these purveyors of long-term contracts to, of a sudden, alter an existing contract or create a new one that accomplishes the same useful result and contemplates the discovery of this novel invented device—a result that prohibits the use of statute of limitations laws in order to preserve the legal viability of long-term contracts—this inventor believes such an action would necessarily infringe the concept and utility of this invented device, as well as irreparably damage its ultimate marketplace potential.

Objects and Advantages of the Invention

The invention has for an object to provide restoration of the ability of contract purchasers to rely more substantially on the duty-to-perform duration of contract promises as they appear in written contracts.

It is another object of this invention to provide restoration of a contract party's right to a legal remedy for breach-of-contract or other legal dispute beyond the limitations period prescribed by law or other time-delimiting criteria.

It is another object of this invention to provide preservation of a contract party's right to a legal remedy for breach-of-contract or other legal dispute beyond the limitations period prescribed by law or other time-delimiting criteria.

It is another object of this invention to provide suspension of the use of time bar devices, statutes or provisions by a contract party throughout the active life of the contract itself.

It is another object of this invention to provide for contract parties a new level of protection for assets pledged against contract agreements.

It is another object of this invention to provide public awareness and education about the impact on the right to seek a legal remedy in court for contract disputes that arise after a prescribed period of time.

It is another object of this invention to provide benefits of the invention in all legal jurisdictions where it may be used by using computer databases to customize terms of the device to conform to the laws and conditions of all such jurisdictions.

It is another object of this invention to provide contract parties with a new level of assurance, in that their contract partners will agree to perform contract duties and obligations as they have pledged to do within a contract to a greater degree of predictable certainty and reliability.

It is another object of this invention to provide disincentives for one contract party to exact penalties, or cause differential treatment of contract partners, because of their use of the invention device.

It is another object of this invention to use computer storage means to provide protection, recording and archiving of the authorized invented device.

It is another object of this invention to provide ongoing neutral monitoring of, and representation for, the objects of this invented device by an outside party who is not a direct party to a contract to which this device applies.

It is another object of this invention to provide computer-generated data comprising a research basis for the development of empirical data about the use of this device in the marketplace.

It is another object of this invention to provide a computer-assisted contingent, backup means, to produce time interval data that is incorporated within the body of the invented device itself, for achieving the goals of the invented device should the primary means for achieving the goals be proved insufficient under certain statutory or regulatory conditions.

It is another object of this invention to provide for the accomplishment of all goals made achievable by the invented device in electronic or digital form, either in combination with, or without any use of paper documents.

It is another object of this invention to provide a customized, computer-generated legal contract from a stored database means containing a plurality of statute of limitations laws, legal jurisdictions, standard and universal contract provisions, and contract identification indicia.

It is another object of this invention to provide a time-based computer tracking and reminder system for the purpose of reaffirming provisions of the invented device at a plurality of set time intervals established according to the statute of limitations laws in a plurality of legal jurisdictions.

It is another object of this invention to provide a computer means for automatic generation of customized notification documents and confirmation documents for contract parties who use the invented device.

It is another object of this invention to provide a computer means for posting a plurality of contract party profiles to a secured Internet portal accessible only to that plurality of entities licensed to use or market the invented device and computer system.

It is another object of this invention to provide a competitive marketplace advantage to licensees of this invented device who will use the benefits of this device to distinguish their contracts as vastly superior to their competitors' contracts because of the additional consumer protection it provides, thereby increasing market share for the licensees.

It is another object of this invention to provide a computer means for generating automatic cancellation notices for use by contract parties to officially cancel former contract agreements with former contract partners who decline to endorse the provisions of the invented device in connection with the former underlying contract agreement.

It is another object of the invented device to provide a means for gathering into a computerized database contract party identification information and contract document identification information by the use of customized form documents and computerized optical scanning devices.

It is another object of this invention to provide an overall reduction in the public and private expense associated with the bringing of futile, legally time-barred lawsuits. By use of the invented device, a contract party eliminates the legal opportunity for a contract partner who breaches the contract to use statute of limitations laws, or similar time bars, to escape legal liabilities and performance duties owed under express terms of the contract, thereby encouraging contract performance or settlement, and thereby reducing the overall volume of such cases.

It is another object of this invention to provide a solution for contract parties who already are acutely aware of the problem addressed by this invention by virtue of having already experienced the denial of their rights to a legal remedy for contract breach because of time bar statutes or other time restrictions, but who, until the introduction of this invention, will have had no choice but to reenter this same perilous situation in new contract agreements they have signed without benefit of any additional safeguards.

### BRIEF DESCRIPTION OF THE DRAWINGS

FIG. 1 is a perspective left-side view of a printed, perforated, accordion-folded document constructed in accordance with the invention, showing the surface leaf lifted at the top end. (Leaf Section A)

FIG. 2 is a perspective second-leaf frontal view revealing a plurality of detachable sections, a plurality of data fields, printed language and a plurality of authentication indicia, appearing in accordance with the invention. (Leaf Section C)

FIG. 3 is a business method and process flow chart, showing an end to one possible outcome of the business process and a continuation of the business process for another possible outcome of the business process.

FIG. 3A is a business method and process flow chart, showing continuation of the business process and an end to one possible outcome of the business process.

FIG. 4 is a graphic depiction of computer elements and Internet interactivity of the business management model and computer controlled processes.

REFERENCE NUMERALS IN DRAWINGS

| | | | |
|---|---|---|---|
| 10 | data field - serial number | 12 | data field - identification |
| | | | data |
| 14 | contract terms | 16 | signature field - Party 1 |
| 18 | seal | 20 | fold perforation |
| 22 | watermark | 24 | perforation |
| 26 | drawing label | 28 | data field - code statute |
| | | | data |
| 30 | data field - legal jurisdiction | 32 | signature field - |
| | | | Assignee/Party 2/3 |
| 34 | proprietary statement | 36 | data field - proprietary |
| 38 | data field - start date | 40 | data field - end date |
| 42 | Instructions | 44 | signature field - Party 2/3 |
| 46 | data field - identification data | 48 | affidavit language |
| 50-82 | process steps | 84 | client-server module |
| | | | computer |
| 94 | local area network terminal(s) | 98 | printer device |
| 104 | optical form scanning device | 108 | Internet portal |
| 112 | licensed vendor portal | | |

### OPERATION—PREFERRED EMBODIMENT OF THE INVENTION

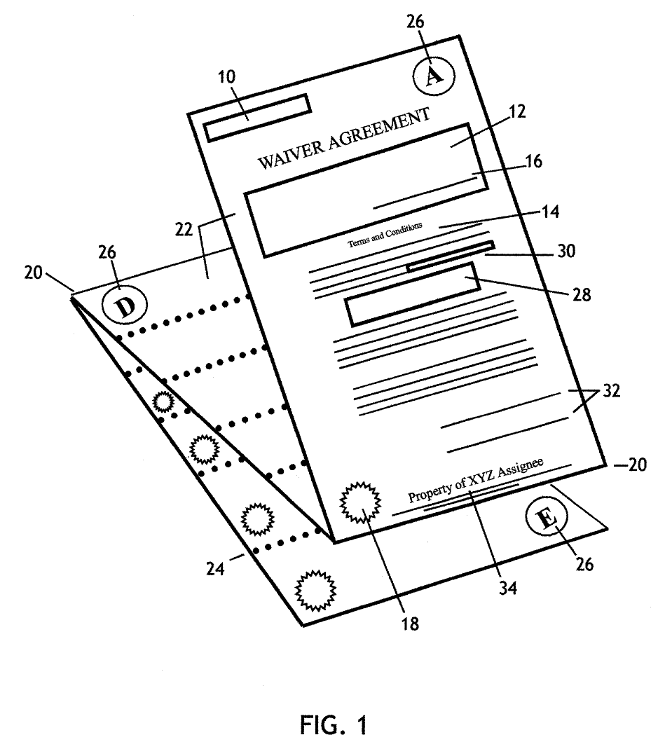

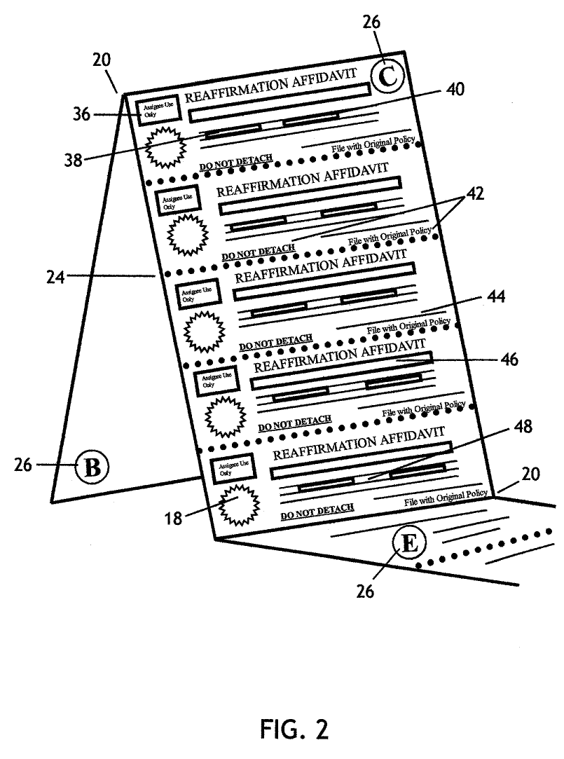

A preferred embodiment of the device of the present invention is illustrated in FIG. 1 (perspective frontal view of leaf section A) and FIG. 2 (perspective frontal view of leaf section C). The accordion-folded, as shown by leaf sections A, D and E (FIG. 1), waiver device has a plurality of 20, 24 perforations for ease of detaching and a plurality of computer-customizable data fields: 10 for a document serial number, 12 for information to identify a contract document to which the device applies and a contract party #1 beneficiary of device waiver advantages, 30 for including the territorial jurisdiction of the device, 28 for the statutory code language of applicable state laws affected by the waiver device, 36 for entering the assignee date and signature on affidavit detachment, triggering active renewal and restatement of terms of the waiver device for the 38, 40 recorded active period of the affidavit, and 46 for entering data to identify the parent contract and serial number of the parent waiver device. The device also contains a plurality of signature fields: 16 for the signature of the contract party #1 beneficiary, 32 for the waiver device assignee and either contract party #2 or contract party #3, and 44 for either the contract party #2 or the contract party #3.

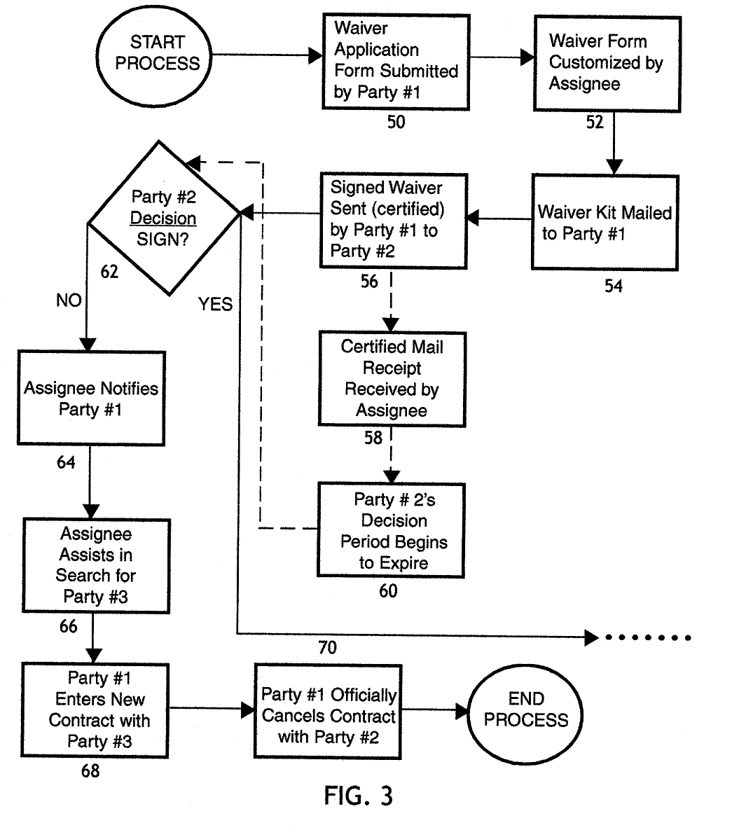

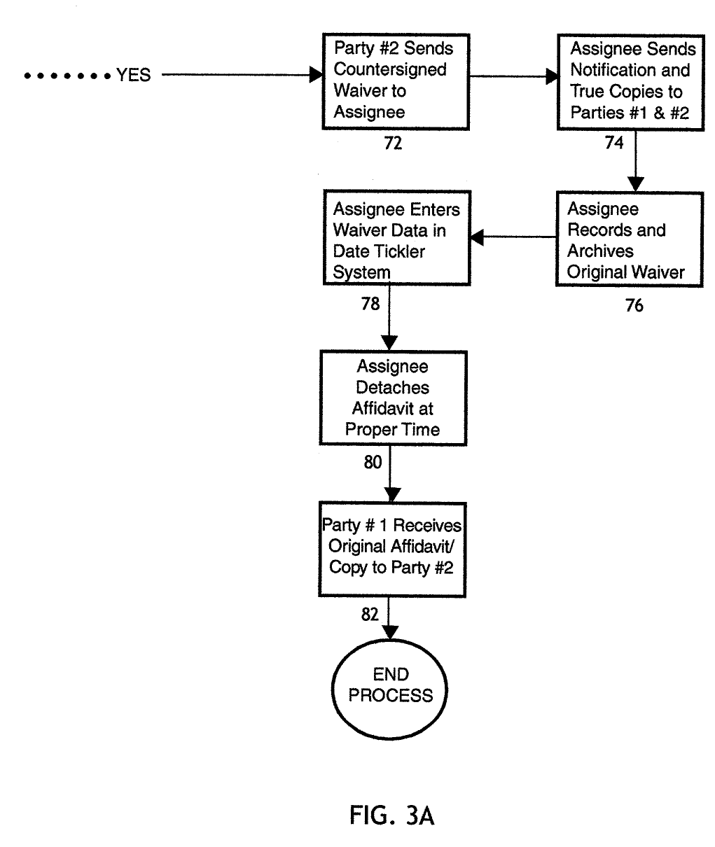

The preferred manner of use of the invented waiver device occurs after submission to the invention assignee of a computer-scannable application form from a contract party #1 50 (FIG. 3). The assignee uses data from this application form to customize the waiver device 52, by transferring data either manually or aided by computer apparatus, into the appropriate data fields described herein and appearing on leaf section A (FIG. 1). This information includes, but is not limited to: the contract identification number and type from the contract to which contract party #1 intends to apply the waiver device, the contract name and description, the contract duration period and personal identifying information about the contract party #1 intended user of the waiver device, geographic residence of the contract party #1, etc. Upon completion, the assignee records the serial number of the waiver device in a computer storage data file established for contract party #1 and maintained by the assignee. Then the assignee inspects all authentication indicia of the waiver device leaf sections A, B, C, D and E for accuracy and quality of reproduction, such authentication indicia comprising 18 embossed or self-adhesive seals, 22 watermarks, 10 a unique serial number, and 34 a statement of proprietary ownership of the waiver device by the assignee. Following a successful inspection, the invented waiver device is bundled with instruction forms and user information in a package which then is delivered 54 (FIG. 3) to a contract party #1 applicant for the waiver device. At the sole discretion as to timing of contract party #1, the waiver device will be signed 16 (FIG. 1) and mailed by means of U.S. Postal Service certified, return-receipted method, along with a pre-printed form letter and other instructional materials prepared by the assignee, to the contract party #2 partner in the targeted contract 56 (FIG. 3). The postal return receipt will be addressed for return to the assignee, not to the contract party #1. Upon receipt by the assignee of this postal receipt 58, assignee will retrieve the data file of contract party #1 and record therein the actual date that the waiver device was received by contract party #2. The 60 pre-established, fixed allowable period for consideration of a decision by contract party #2 begins to expire on the receipt date indicated by the postal return receipt. The computer system activates an internal time-tracking calendar and reminder apparatus to automatically notify at the end of the contract party #2's consideration expiration period. A failure by contract party #2 to respond within this time period automatically will be recorded by computerized process in the file of contract party #1 as a declination, and a computer-generated notification will be delivered by the assignee to contract party #1 64. The assignee then actively assists contract party #1 to locate a contract party #3 66, using a computerized Internet-based data portal only accessible to assignee-licensed vendors. Licensed vendors will provide offers to contract party #1 of a replacement contract(s) of identical, better or similar terms, conditions and considerations as that contract held by contract party #1 and contract party #2, but who also will agree, in advance, to sign the invented waiver device. Upon successful creation of a valid contract between contract party #1 and contract party #3 68 which incorporates the invented waiver device, contract party #1 formally cancels 70 the former contract agreement that existed with contract party #2. The assignee provides the final signature 32 (FIG. 1) to the new contract and becomes the archival custodian of the original authorized waiver device. True copies are delivered to contract party #1 and contract party #3. The established relationship posits the assignee and the contract party #3 as the direct signatories and actual contractual partners as regards the agreements represented by the invented waiver device, while it posits contract party #1 and contract party #3 as the direct signatories and contractual partners to the underlying contract agreement to which the invented waiver device applies. By this means, contract party #1 becomes the third-party beneficiary to the waiver device and is entitled thereby to all of the benefits, protections and considerations pertaining thereto. Also by this means, the assignee gains a vested interest in the performance obligations owed to contract party #1 as expressed in the underlying contract agreement between party #1 and party #3. As a direct signatory to the waiver device agreement, the assignee also gains direct, independent legal standing for a claim that may be brought against contract party #3 in the event that the terms of the waiver device are repudiated or breached, irrespective of any legal claim that may or may not be brought directly against party #3 by party #1 for a breach of their separate underlying contract agreement.

If contract party #2 decides to sign the waiver device 62 (FIG. 3), 32 (FIG. 1) providing all signatures required by the device and its attached affidavits 44 (FIG. 2), returning it, duly authorized, to the assignee within the prescribed time period, the process follows a different course. Then contract party #2 delivers the properly countersigned waiver device to the assignee 72 (FIG. 3A), and the assignee provides the final signature and notifies contract party #1, sending true copies of the waiver device to contract party #1 and contract party #2 74.

The assignee next records the agreement in the file maintained for contract party #1 76, and enters the trigger dates specified in the attached affidavits into a computerized reminder, or tickler, system to ensure that the affidavits are detached and disseminated in a timely manner. It is important to note that the time period of the detachable affidavits and computerized tickler system are an invented means in the waiver device to act as a contingent backup method for restating and reactivating original terms of the device, without the need to renew the underlying contract, at the appropriate future period that falls within the legal time limits established by statutes of limitations in those applicable states or jurisdictions where the waiver device is used. A computer database comprising limitations statutes for a plurality of applicable jurisdictions is used to populate the appropriate empty data fields present in the invented device. For example, in a state or jurisdiction where the statute of limitations on contract disputes is six years, the first affidavit is detached and disseminated prior to expiration of this period 80 (FIG. 3A). The period end date 40 (FIG. 2) is affixed on each affidavit during the assignee's customization stage, before the waiver device is sent to contract party #1. Near the end date for the first affidavit, the second affidavit is detached and disseminated, the original going to contract party #1 and a true copy 82 (FIG. 3A) going to contract party #2 or #3, as the case may be. These affidavits do not take effect or hold legal validity until they are detached at the appropriate time by the assignee, such effective date of detachment being noted on each affidavit 36 (FIG. 2) at the time of detachment. The first means for accomplishing the goals of the waiver device are contained in the body of terms and conditions appearing on leaf sections A (FIG. 1) and B (FIG. 2).

### AN ALTERNATIVE EMBODIMENT OF THE INVENTION

Another embodiment of the invention involves the ease-of-use, minimal involvement of the contract party #1 user of the invented device. In operational aspects, the invented device itself operates virtually the same as stated in the preferred embodiment, and is incorporated by reference herein, with the principal difference occurring in the manner of physical handling and process steps associated with activation and use of the invented device. The present embodiment requires that the existing contract party #1 only identify contract party #2, identify the name or type of contract agreement and sign an authorization for the third party licensee of this invented device, or its authorized representative, to contact contract parties #2 and #3 in order to operate for this purpose in behalf of contract party #1.

Detail of Computer-Enabled Operations

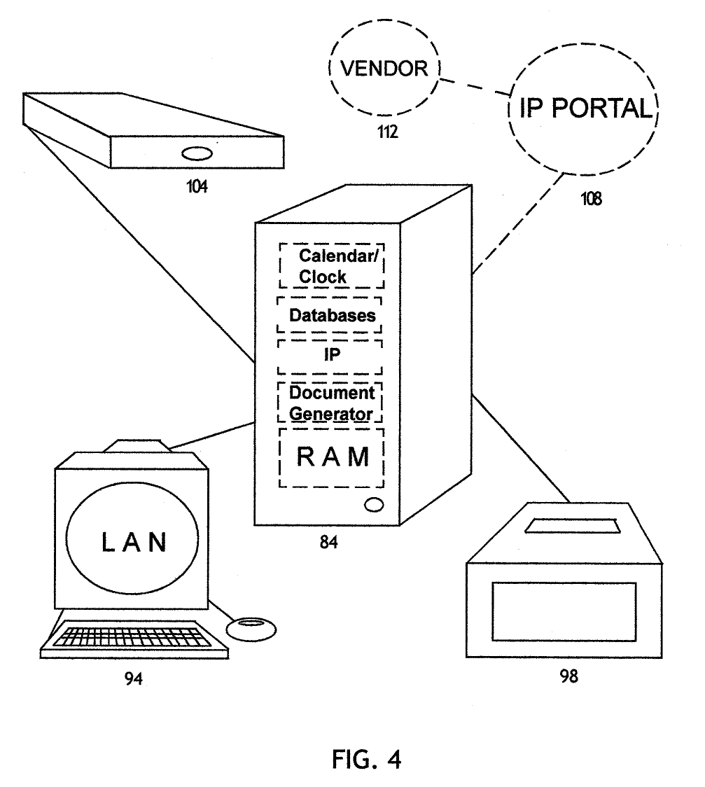

Contract party #1 submits an application form requesting use of the proprietary invented device. The form is optically scanned by a scanning device 104 (FIG. 4). The data field information is digitized by the scanning device and then captured into the client-server module's 84 database storage medium. A digital identifying tag automatically attaches to each initial set of individually scanned form data, creating a distinct client file for each separate scanning transaction. This identifying digital tag is used throughout the process for properly assigning new data to the proper files and fields in the various computer applications that thereafter will interface with the client-server module. This same tag allows for the accurate retrieval of client-specific data on a command basis and assures accurate interactive transactions with the Internet-based portal applications 108. Using available calendar software 84, the client-server module logs the initial data input date and time. Every transaction activated against this tagged file is digitally logged throughout the active life of the data file component. Upon activation via a user of a LAN terminal 94 connected to the client-server module, the client-server module responds to a print-preview command in order to retrieve and assemble the requested stored data from an established client file in order to populate the empty data fields present in the terminal screen representation of the actual pre-printed invention device. The client-server module references the stored client input database file 84, and sub-fields contained therein, to point to the appropriate data items stored in the database of legal statutes 84, the database of legal provisions and clauses 84, the database of sequential serial numbers assigned to each issue of the invented device 84, the appropriate database of dates to establish affidavit interval periods based upon statutory limitations periods in the appropriate jurisdiction 84, and identification information for the client and the targeted contract to which the invented device will attain. Having thusly populated the screen print preview, the client-server module either awaits a confirmation and print command from the terminal user (the default condition), or automatically sends the print command to the printer device 98 for a finished customized version of the invented device and later physical review. The client-server module automatically posts the contract party #1's profile of replacement contract data (without personal information divulging contract party #1's identity) to the Internet-based secured vendors' portal 108, who then begin their search for a comparable replacement contract with a contract party #3. Licensed vendors review this portal on an ongoing basis to review posted, anonymous client contract needs and claim those profiles for which they will seek replacement contracts. Once claimed, the vendor posts to the profile his vendor number and transmits the claim to the client-server module, where a database of approved licensed vendors exists 84. On a daily basis, the client-server module uses its report generator 84 to issue a tabulation of claimed cases during the previous 24-hour period. After posting the appropriate data to the portal, the client-server module digitally compresses and places the client's file, including the digitized version of the customized invented device, in a suspense folder within an internal storage area for possible future activation by a user. Once reactivated by the input of a user entering a certified-postal return receipt date, the client-server module assigns a process start time and triggers an internal timing device 84 which continually monitors, tracks and digitally stores a time-sequenced transaction log process within the client's data file. Using data from the internal timing device, the client server module will send a prompt to the terminal screen warning of the pending expiration of the contract party #2's 30-day consideration period. Failing receipt of a command override from the user, the client-server module automatically marks the file “declined” on the 31st day and uses its internal document generator 84 to process a print command for the printer device in order to generate a notification letter to be delivered to contract party #1. Simultaneously, it sends a terminal prompt to the user asking for authorization to automatically post the contract party #1's personal identity and demographic information into the existing profile of replacement contract data already residing at the Internet-based secured vendors' portal. Once identities have been posted to a client profile, vendors make direct client contact with offers of alternative contract agreements that already contain the client sought-after use of the present invented device. On an ongoing basis, the client-server module uses its report generator component to provide a daily tickler report of affidavits needing detachment from the original invented device on file, authorization to activate restatement of the invented device's provisions for the stated interval period, and delivery to the active contract parties. Because the computerized system continually monitors vendor transactions when claiming a profile, the computer system also calculates license royalty fees due, and it generates invoices.

### CONCLUSION, RAMIFICATIONS AND SCOPE

The invention is a marketing device, computerized system, novel method of use and unique related process steps that allow obligations and performance duties on contracts to be performed throughout the life of such contracts, as specifically expressed in the stated terms and conditions of such contracts. By use of the invented device, computerized system, method of use and process steps, contract duties and expectations can be fulfilled without the prospect of nullification of a contract party's right to a legal remedy for a possible future contract breach. Such denial of a legal right to a remedy on older contracts occurs routinely; whenever a court imposes statute of limitations laws and other time-based limitations and provisions on legal contract rights from the moment a contract is created, and irrespective of whether or not these legal limitations periods ever have been disclosed to the contract parties involved.

The device, computerized system, method of use and related process steps claim a broad range of applicability to long-term consumer and commercial contracts routinely used in ordinary transactions and formalized agreements in every area of marketplace activity.

The invented device, computerized system, method of use and related process steps influence contract parties in their voluntary decision either to invoke or not to invoke and use a statute of limitations law, or other time-based limitation, as a litigation defense to avoid contract obligations in any future dispute or claim arising from, or pertaining to, a contract. The effect of this present invention's influence is to restore a contract party's right to gain legal relief for any breach that occurs during the entire stated duration of the contract, thereby allowing contract parties to increase the level of reliance they can place on contract promises, encouraging all contract parties to perform their contract obligations because this legal loophole will not longer apply, and encouraging parties to settle their disputes out-of-court rather than waste the significant public and private financial resources spent each year in expensive, but futile, legal cases that fall within the scope of this statutory loophole. Because of this, an indirect but important advantage of the invention is its object for reducing the overall volume of contract lawsuits, most of which are caused by recalcitrant contract party defendants who seek to exploit this legal loophole to escape contract obligations and avoid paying a settlement out of court. Based on a strategy of denying the plaintiff contract party's right to a legal remedy, a contract party defendant can successfully exploit this condition in the law to avoid settlement costs or legal liabilities owed under a contract that is older than the state's statutory limitations period. The history of court rulings on such litigation shows that the odds that this loophole will work is so extremely favorable that many contract party defendants have incorporated this tactic as a standard component of their permanent legal strategy for contracts they sell—and later—breach and dispute. Curiously, therefore, the breaching contract party defendant is able to rely and depend on the unfailing nature of this legal loophole with a much greater level of certainty and court protection, than his own contract partner can ever legally rely and depend upon the written language of the failing contract itself, or on the courts. Courts very rarely rule in the plaintiff contract party's favor when a statute of limitations argument is introduced in contract litigation. By establishing a tangential contract agreement that prohibits the use of this loophole in future disputes, the present invention provides greater overall protections, and significantly improved levels of trust, reliability, disclosure, legal justice and predictability for all contract parties.

While only two embodiments have been shown and described in accordance with the present invention, it is understood that the same is not limited thereto, but is susceptible to numerous changes and modifications as known to one having ordinary skill in the art, including for example use of the invented device directly between contract parties without involvement of a third entity, or use of the invented device by electronic means online or otherwise with some or no paper elements, or use with altered terms, wording, layout and appearance, or use manually without aid of a computer-based system, or use as an incorporated clause or term in the original body of a contract document itself, but each of these modifications used in a manner designed to substantially achieve the same result. Therefore, the inventor does not wish to be limited to the details shown and described herein, but intends to cover all such modifications as are encompassed by the scope of the claims herein stated.

I claim:

1. a written device, computerized system, method of use and process steps comprising a first means for adding legally binding language to an original contract as a device selected from the group including contract amendments and memoranda of agreement and original contract terms and integrated contract terms and waivers and appendices and codicils and wills and estate documents and covenants and riders, whereby the provisions of said device integrate into said original contract before or after creation of said original contract as if fully and originally incorporated into the body of said original contract in order to forbid the use of statutes of limitations laws or other recorded time limitations as a litigation defense against otherwise time-barred legal remedies in disputes arising from or pertaining to said original contract, and
(a) a second means for a first party to said original contract to use said device to bind a second party to said original contract to a second original contract embodied in said device, whereby said first party becomes a neutral third-party beneficiary of the agreement established by said device that binds said second party and the owner/licensee of said device in said second original contract.
(b) a third means for extending and incorporating agreements embodied in said second original contract as integral terms and conditions of said original contract as if stated in said original contract at the time of consummation, overriding and nullifying any pre-existing terms or conditions of said original contract that permit the use of said statutes of limitations or other recorded time limitations as a litigation defense.
(c) a fourth means for enabling a third-party representative or licensee of the invented device, as legally authorized by said existing contract party or potential contract party, to represent said existing or said potential contract party to effectuate the activation and operation of the invented device in said existing or said potential contract party's behalf.

2. A written device, computerized system, method of use and process steps that enable said potential party to a contract, or said party to an existing contract, to pre-condition the grant of consideration for a potential contract, or the continuation of said existing contract, on the use of said written device in connection with said potential contract by potential contract partner(s) before creation of said potential contract, or after creation of said existing contract, in order to forbid the use of statutes of limitations laws or other recorded time limitations as a litigation defense, whereby future contract disputes that would otherwise be legally time-barred can attain a legal remedy at any time during the extant life of said existing contract or said potential contract, as said life of said existing contract or said potential contract is originally expressed in the terms, duties and conditions of said existing or said potential contract.

3. The computerized system of claim 2 wherein an automatic tracking and reporting capability records transactions and calculates royalty fees due on existing licensing agreements.

4. A written device and method of use for preventing the use of statutory or other time limitations on contract performance obligations and legal liabilities for a contract breach that preserves a contract party's right to a legal remedy, comprising as follows:
(a) providing a customizable form for use by a contract party in order to identify an existing or potential contract agreement to which the invented device will apply,
(b) providing instructions for proper use of the customizable form with an existing or potential contract partner,
(c) providing validation and archiving of the signed and countersigned form, sending true copies to all contract parties of record,
(d) providing assistance to a contract party user of the form whose contract partner refuses to sign the form or accept the application of the invented device's provisions to a parent contract in locating a suitable replacement contract partner who will sign the invented device and accept its provisions in a parent contract,
(e) providing periodic reinstatement of the invented device's provisions at appropriate times throughout the stated duration of the contract, without the need to renew the parent contract, and effectively preventing the use of statutory or other time limitations on the right to a legal remedy for any contract dispute arising from or pertaining to the parent contract throughout the stated period of the contract's duration,
(f) gaining legal standing for an assignee, as a direct signatory to the invented device, to institute legal actions against violators of the invented device's provisions, irrespective of whether any legal action is undertaken by parties to the parent contract to which the device applies.
(g) Providing a computerized system to automate process steps to create customizable forms, store and retrieve statutory data by legal jurisdiction, store and retrieve standard and universal contract provisions and language, store and retrieve contract party data, store and retrieve contract document data, compile all such data in a plurality of combinations to generate targeted legal contract documents, automatically track, remind and alert regarding expiration time periods, provide automatic, interactive interface with Internet-based applications and data processing systems, generate customized correspondence, calculate royalty payments due, generate invoices and digitally archive signed legal documents.
(h) Rendering as non-existent and as legally unenforceable under said contract any and all performance duties, expectations, obligations, terms, conditions, exclusions or exceptions unless such said performance duties, expectations, obligations, terms, conditions, exclusions or exceptions were fully disclosed and conveyed in writing to, and also were in the physical possession of, said potential or said existing contract party within the text of the original contract document at the time of creation, with the understood exception of said present invented device as applied to a pre-existing contract.
